(19) United States
(12) Patent Application Publication
(10) Pub. No.: US 2004/0244721 A1
(43) Pub. Date: Dec. 9, 2004

(54) Non-staining, contrasting animal hide pet chew and method of making same

(75) Inventors: Jacob Tepper, Boca Raton, FL (US); Steven Mendal, New York, NY (US)

Correspondence Address: WEINGRAM & ASSOCIATES P.C., P.O. BOX 927, MAYWOOD, NJ, 07607, US

(73) Assignee: PETRA PET, INC. d/b/a PETRAPPORT

(21) Appl. No.: 10/810,321

(22) Filed: Mar. 26, 2004

Related U.S. Application Data
(60) Provisional application No. 60/458,208, filed on Mar. 27, 2003.

(51) Int. Cl. A01K 29/00

(52) U.S. Cl. 119/710; 426/805

(57) ABSTRACT

A novel pet chew comprising a plurality of contrasting animal hide strips joined together, where at least one of the plurality of contrasting animal hide strips is treated to be non-staining, is disclosed. The chew is configured to display substantial portions of each of the plurality of contrasting animal hide strips on the exterior surface of the chew. A method of making a non-staining pet chew is also disclosed.

### BACKGROUND OF THE INVENTION

1. Field of the Invention

The present invention relates to non-staining pet chews for dogs, and a method of making same. More particularly, this invention relates to non-staining, consumable animal hide chews configured to display substantial portions of each of a plurality of contrasting animal hide strips on the exterior surface of the chew and to a method of making dog chews so they do not stain furniture, carpets, or other articles.

2. Description of the Related Art

Teething toys and dog chews of rawhide, jerky, nylon, polyurethane, plastic and other synthetic materials are known to satisfy a dog's instinctive urge to chew, reduce plaque build-up and massage gums. Prior dog chews made of rawhide, rolled and knotted in the shape of a bone or other shapes, satisfy a dog's need to chew and are easier to digest than chews made of synthetic materials. Basting or coating chews in flavoring marinades enhances the taste and aroma of the rawhide chews and stimulate and maintain a dog's interest in the chew. However, flavored dog chews may stain carpets, furniture or other articles and some people find their aroma unpleasant. Accordingly, there is a need for a chew which appeals to dogs, is long-lasting, satisfies a dog's need to chew and cleans the dog's teeth, yet which does not stain carpets or smell unpleasant.

Numerous references describe the production of dog chews. However, none of these references teach or suggest the specific novel, non-staining dog chew of the invention.

Knotted bones pet chews made of single strips of rawhide are known in the art. However, these chews are prone to stain decorative surfaces with which they come into contact.

U.S. Pat. No. 5,673,653 to Sherrill discloses a dog chew made by wrapping or folding a sheet of rawhide with a sheet of jerky superimposed on it. The chew is not coated or basted so as to avoid staining carpets and other household articles. Only a minimal portion of the jerky sheet extends through a seam in the rawhide sheet and is exposed outside the outer rawhide layer, to minimize the risk of staining carpets and other items.

U.S. patent Publication No. 2003/0106500 to Kirch discloses a rawhide pet chew made by folding a first sheet of rawhide around a second sheet of rawhide which is flavored relative to the first sheet of rawhide, so that only an edge of the second sheet of rawhide protrudes from under the unflavored, first sheet of rawhide to entice the pet to consume the chew. When the chew is positioned on a generally flat surface, only portions of the unflavored, first sheet of rawhide contact the flat surface. The flavored, second sheet of rawhide does not contact the flat surface to prevent staining of the surface.

However, among the foregoing patents, none disclose or suggest a pet chew which is non-staining so it may be placed on any surface without fear of staining carpets or other household objects, and which combines a plurality of animal hide strips which contrast in at least one of flavor, color, texture and material, in a configuration and manner appealing to a pet. Specifically, none of the prior art teaches or suggests a pet chew comprising a plurality of contrasting animal hide strips that are joined together, at least one of the plurality of contrasting animal hide strips treated to be non-staining, and the pet chew is configured to display substantial portions of each of the plurality of contrasting animal hide strips on the exterior surface of the chew.

The contrasting animal hide strips contrast in at least one of flavor, color, texture and material. That is, at least one of the plurality of contrasting animal hide strips treated to be non-staining may be flavored with a flavoring agent or may be colored or textured. Another of the contrasting animal hide strips may be natural animal hide, i.e., unflavored and not artificially colored or textured animal hide. Alternatively, another of the contrasting animal hide strips may be differently flavored, colored, or textured relative to the first animal hide strip. Furthermore, the chew of the invention may comprise a combination of animal hide strips obtained from different species of animals, such as from pigs, cows or other animals.

The chew is configured so that substantial portions of each of the plurality of contrasting animal hide strips are exposed or visible on the outside surface of the chew. The present invention produces an improved simulated non-staining animal chew which has a pleasing taste, color, and appearance, is nutritious, and is suitable as a plaything or dog food. At least one of the contrasting animal hide strips may further contain at least one additional ingredient selected from the group comprising nutrients, dental additives, pharmaceutical compounds and mixtures thereof.

### OBJECTS AND SUMMARY OF THE INVENTION

It is an object of the invention to provide an improved pet chew which is non-staining and can be placed on any surface.

Another object of the invention is to provide a pet chew which satisfies a dog's chewing instincts and which appeals to the dog so the dog is initially attracted to and sustains interest in chewing the item for extended periods of time.

A further object of the invention is to provide a chew configured to display substantial portions of each of a plurality of contrasting animal hide strips comprising the chew on the exterior surface of the chew.

It is an object of the invention to provide a method for preparing non-staining animal hide dog chews.

It is an object of the invention is to provide non-staining animal hide dog chews which are multi-colored and/or flavored and/or textured.

It is a further object of the invention to provide novel dog chews which are made from a plurality of animal hide strips obtained from various animal species.

It is a further object of the invention to provide novel dog chews which are made from a combination of cowhide and pighide.

Another object of the invention is to provide a dog chew which is safe to ingest, improves the dog's oral hygiene and adds nutritional value to the dog's regular diet.

A further object of the invention is to provide a dog chew which does not stain furniture, carpets, or other articles and does not have an offensive odor.

Yet another object of the invention is to provide a long-lasting, non-staining dog chew that piques a dog's interest and maintains its integrity so that it is suitable for repeated use.

Another object of the invention is to provide a dog chew toy that help keeps a dog's teeth plaque and tarter-free and that massages the dog's gums when the dog chews on the chew.

A further object of the invention is to provide an improved animal hide pet chew for delivering nutrients to pets.

A final object of the invention is a method of making a dog chew that is easy to manufacture and economical.

These and other objects are accomplished by providing dog chews which are improved as compared to commercially available dog chews, as they are made from animal hide cut and shaped to a desired appearance and configuration to appeal to dogs, treated to be non-staining, and comprising a plurality of contrasting animal hide strips joined together in desired configurations that contribute to its interesting and aesthetically pleasing appearance. The chew comprises contrasting natural animal hide, or at least one colored, flavored or textured animal hide strips, or, alternatively, animal hide obtained from different species of animals. In one embodiment of the invention, the chew comprises a combination of pighide and cowhide.

In another aspect of the invention, there is disclosed a method of making a dog chew comprising a plurality of contrasting animal hide strips joined together by means of at least one operation selected from the group consisting of intertwining, tying, binding, rolling, folding, overlaying, looping, braiding, twisting, wrapping and knotting. The pet chew is configured to display substantial portions of each of the plurality of contrasting animal hide strips on the exterior surface of the chew.

In one embodiment of the invention, the contrasting animal hide strips are aligned in a partially overlapping position, a rawhide roll is optionally inserted at a point intermediate the ends of the strips, the strips are rolled up longitudinally, and the ends knotted. Insertion of a rawhide roll intermediate the ends of the strips is recommended when producing dog chews having a length over about five inches to give the chew a preferred shape. For chews under about five inches in length, small pieces of rawhide may be inserted to give the chew a more desirable shape.

In a further aspect of the invention, there is disclosed a method of making a non-staining dog chew.

Various flavors, scents, dental additives, nutritional supplements, pharmaceuticals or other additives may be added to at least one of the plurality of contrasting animal hide strips used to form the animal hide chew of the invention. The chew is enriched with nutrients, dental additives, pharmaceutical compounds and mixtures thereof to provide the pet with nutritional, therapeutic and amusement benefits. Chewing exercises, cleans and massages the pet's teeth and gums and precludes the pet from chewing on other, possibly harmful, objects.

These, and various other and further features and advantages of the invention will become apparent from the following detailed description, taken in conjunction with the accompanying drawings, which illustrate by way of example the principles of the invention.

### BRIEF DESCRIPTION OF THE FIGURES

FIG. 1 is a top view of the contrasting animal hide strips used to make the pet chew of the invention;

FIG. 2 is a side perspective view of the contrasting animal hide strips of FIG. 1 in a partially overlapping position showing the positioning of a rawhide roll;

FIG. 3 is a side view showing a further advanced stage of assembly;

FIG. 4 is a view of the assembled strips in preparation for knotting;

FIG. 5 is a view of one stage in the knotting operation;

FIG. 6 is a perspective view of the partially knotted chew;

FIG. 7 is a perspective view of the fully knotted chew;

FIG. 8 is a perspective view showing trimming of the excess material;

FIG. 9 is a top plan view of the pet chew of the invention; and

FIG. 10 is a front view of the chew of the invention.

### DETAILED DESCRIPTION OF THE INVENTION

The present invention provides a nutritious, long-lasting, non-staining and completely digestible chewable toy for dogs comprising a plurality of joined together, contrasting animal hide strips configured to display substantial portions of each of the plurality of contrasting animal hide strips on the exterior surface of the chew to form a unique, aesthetically pleasing dog chew. The contrasting animal hide strips may contrast in at least one of flavor, color, texture or material to enhance its appeal to the pet. One animal hide strip may be natural, that is to say, non-flavored, non-colored, and/or non-textured, to thereby provide a contrast with a second colored, flavored or textured animal hide strip. Alternatively, the contrasting animal hide strips may comprise an animal hide strip having a selected flavor, color, texture or material and an additional animal hide strip having a different flavor, color, texture or material than the first animal hide strip. In yet another embodiment, the animal hide strips may comprise hides obtained from different animal species, such as pighide and cowhide. Various appeal-enhancing agents may be added to the animal hide such as seasonings, colorants, or meat or other flavored attractants.

The invention also contemplates a method of making a dog chew in a desired configuration from a plurality of animal hide strips of substantially equal dimensions, such that substantial portions of each of the contrasting animal hide strips are exposed and visible on the exterior surface of the chew. Preferably, substantially equal portions of each of the contrasting animal hide strips are displayed on the exterior surface of the chew. At least one of the plurality of contrasting animal hide strips treated to be non-staining contacts a surface when the chew is placed upon the surface.

The chew may be configured or shaped in any desired size and configuration to appeal to dogs. For example, the chew may be in the configuration of sticks, pretzels, balls, rings, rolls, bagels, retrieving objects, twists, or any other actual, novelty, or abstract shape, so long as substantial portions of each of the contrasting animal hide strips are displayed on the exterior surface of the chew. Chews of different sizes and configurations may be formed by varying the length, width, and thickness of the animal hide strips, suitable for dogs of different breeds and sizes. The chew is desirably sized so that a dog can hold it in its mouth, but cannot easily swallow it whole.

When consuming the pet chew, the dog sinks its teeth into the chew and rubs the chew against its gums while savoring the latent flavor. These efforts not only exercise the dog's teeth, jaws and gums, but also clean the dog's teeth by the abrasive wiping, chewing, and gnawing action of the chew against the surface of the teeth and gums. Tartar or plaque on the pet's teeth is reduced by the action of chewing and rubbing of the chew against the teeth. As the dog has a sustained interest in the chew, the prolonged chewing time results in an increase in the abrasive effect on the dog's teeth surfaces. This helps control plaque and tartar build-up which can lead to gum disease and bad breath.

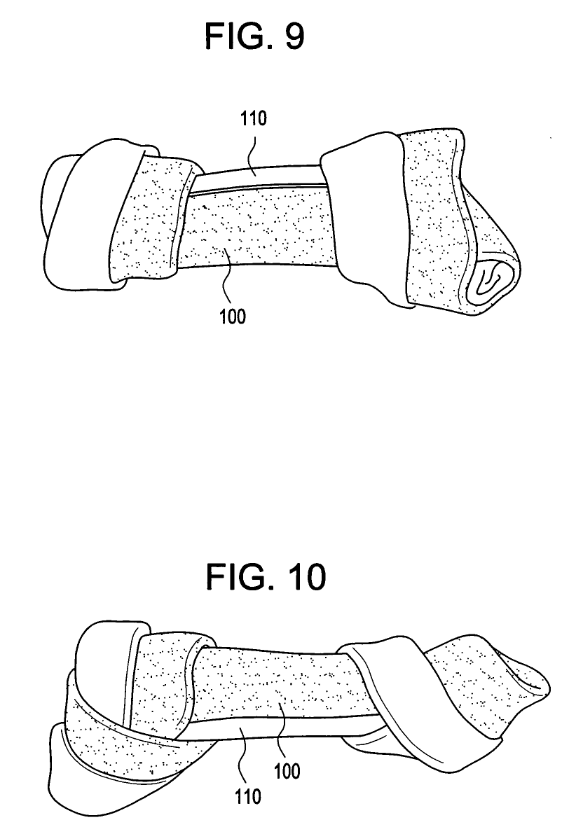

In a preferred embodiment, the chew is made of animal hide in the shape of a knotted bone, indicated generally by reference number 100 in FIGS. 9 and 10. The chew of the invention comprises a plurality of contrasting animal hide strips of equal or substantially equal dimensions, cut, shaped and joined together in the desired configuration such that substantial portions of each of the contrasting animal hide strips are exposed and visible on the exterior surface of the chew. Preferably, substantially equal portions of each of the contrasting animal hide strips are displayed on the exterior surface of the chew, giving the chew a substantially 50-50 contrasting appearance.

The chew toy comprises a plurality of contrasting animal hide strips joined together. The chew may comprise a combination of one or more natural animal hide strips and one or more colored, textured and/or flavored animal hide strips. By “natural” animal hide strip is meant an animal hide strip that is not artificially colored, flavored or textured. Alternatively, the chew may comprise a first colored and/or flavored and/or textured animal hide strip and a second, differently colored and/or flavored and/or textured animal hide strip. Optionally, the chew may comprise a combination of pighide and cowhide.

The animal hide, being heavy, dense, and rigid, provides a long-lasting release for the dog's natural chewing instincts. At the same time, the chew's odor, flavor, and color initially attract the dog's attention and sustain the dog's interest to continue chewing on the chew toy. The chew is thus of long-lasting interest to the dog. This ensures hours of chewing enjoyment for the dog, while at the same time having a beneficial tartar-removing, gum massaging effect on the dog's teeth.

The contrasting external appearance of the chew serves as an attractant and incentive to the dog and a starting point for the dog to begin chewing. The chew toy has a tempting flavor and odor substantially throughout the chew. This will satisfy the dog's chewing urges, keep its teeth clean, and help prevent tartar and plaque build-up, while the flavor and aroma of the contrasting animal hide strips encourage the dog to continue chewing for long periods of time.

The chew is formed in such a way as to give the finished chew an external appearance whereby there is an equal or substantially equal portion of each constituent animal hide strip visible on the exterior surface of the chew. As shown in FIGS. 9 and 10, about one-half of each of the first and second contrasting animal hide strips are visible in the exterior surface of the chew. The chew is formed of two continuous, contrasting animal hide strips which are sufficiently long, and sufficiently strong, to withstand the knotting process, as well as sufficiently deformable so they can be knotted without unduly stretching the animal hide strips.

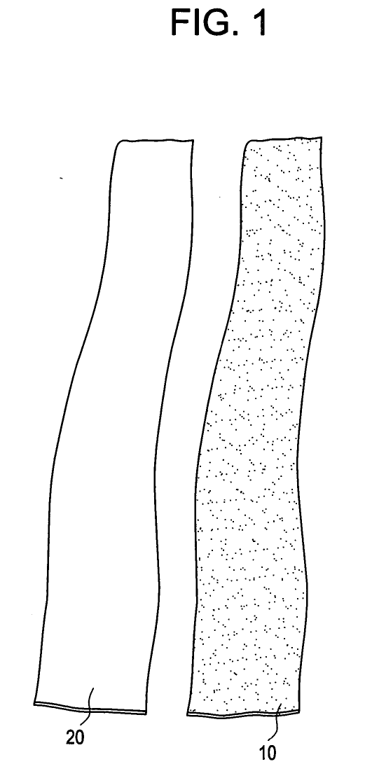

The assembly of the chew 100 of the invention comprises the following steps. The animal hide chew is preferably in the shape of a knotted bone which is a thick, solid, chew-resistant product which can exercise a dog's teeth and jaws. Referring to FIG. 1, two contrasting animal hide strips, 10 and 20, of substantially equal size and dimensions are provided and aligned side-by-side. The animal hide strips may contrast in flavor, color, texture or material. For instance, strip 10 may be flavored animal hide and strip 20 may be natural animal hide, or strip 10 may be pighide and strip 20 may be cowhide. The dimensions of the animal hide strips vary according to the size of the chew bone to be produced. For example, for a 3 to 4 inch bone, the animal hide strips are approximately 17 inches in height and 2 inches in width.

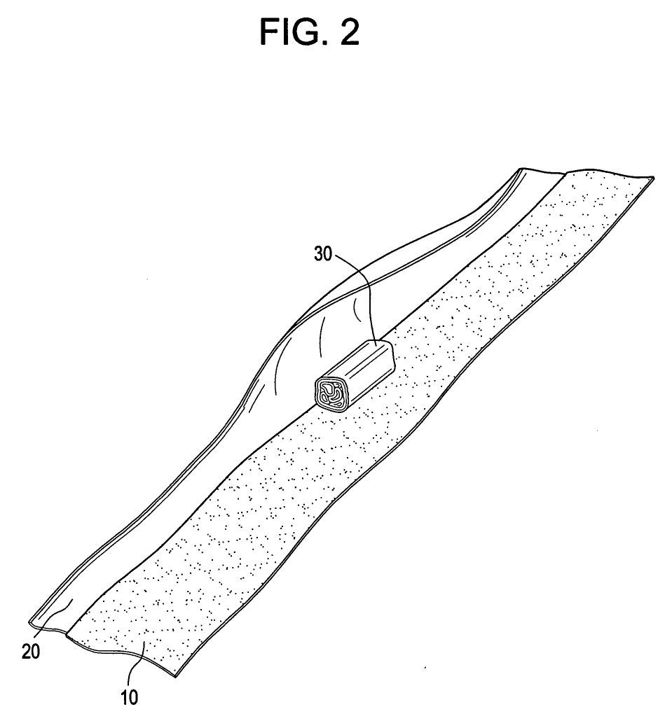

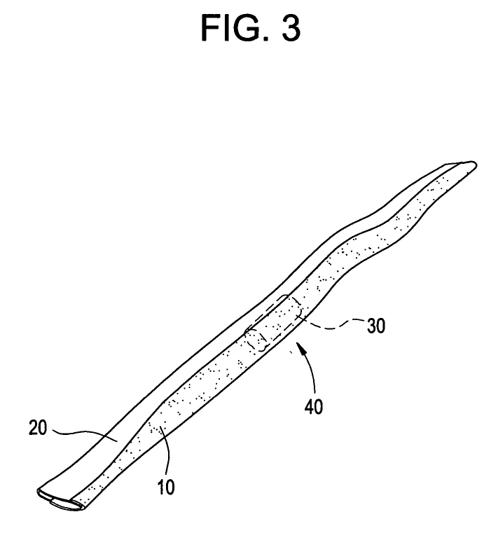

As shown in FIG. 2, the first animal hide strip 10 is then partially superimposed lengthwise on top of a portion of the second animal hide strip 20 so that the first animal hide strip 10 partially overlaps or covers about ¼ of the width of the second, non-colored animal hide strip 20, so as to form a top animal hide strip layer and a bottom contrasting animal hide strip layer along the entire length of the animal hide strips. A rawhide roll 30 is positioned at or near the midway point of the overlapping animal hide strips, at the juncture of overlap of the animal hide strips 10, 20. The roll 30 has been previously formed and dried, so it can hold the shape of the chew to be formed, and will not need extra drying time. As the roll is pre-dried, this reduces the risk of having more humidity in the interior of the chew than in the outer layers, and therefore reduces the risk of generating mold and fungus inside the chew. Inclusion of the rawhide roll gives the finished rawhide bone bulk and rigidity in the portion of the bone intermediate the knots. The dimensions of the rawhide roll varies in accordance with the size of the desired, finished bone. A long roll is used for longer bones, a thicker roll for wider bones, and so forth. The overlapping animal hide strips 10, 20, including the rawhide roll 30 are rolled lengthwise, commencing with the bottom animal hide strip layer 20, so as to completely cover and incorporate rawhide roll 30 FIG. 3 shows the overlapping animal hide strips in a completely rolled-up position, referred to herein as the “roll of animal hide strips”, and indicated generally as 40. The roll of animal hide strips has equal portions of natural and colored rawhide visible, with the rawhide roll no longer visible.

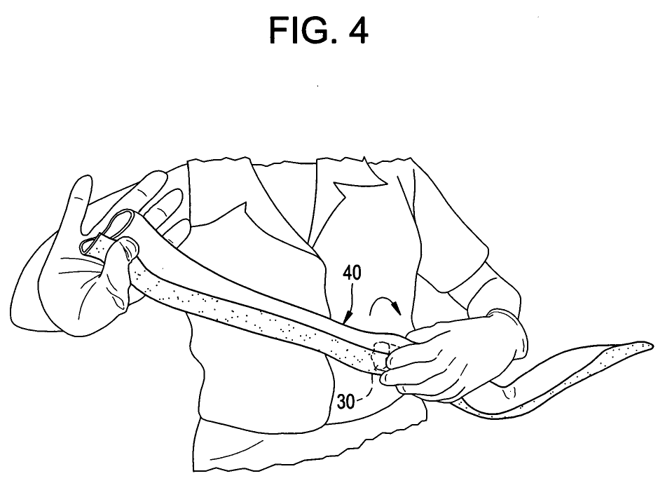

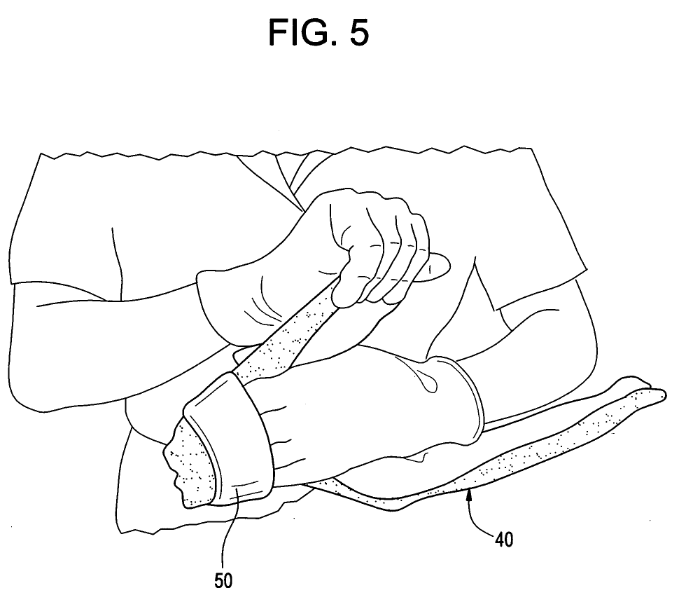

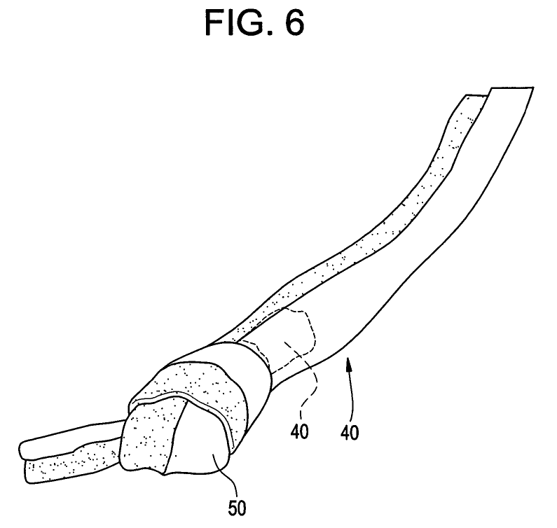

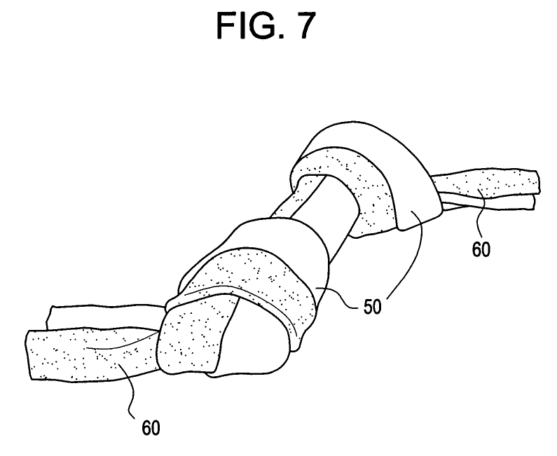

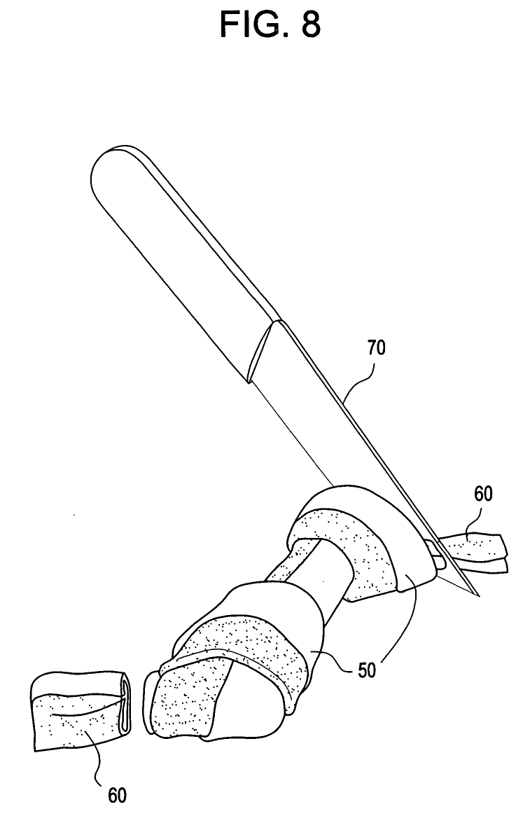

As shown in FIGS. 4 and 5, one end of the roll of animal hide strips is raised preparatory to knotting. The process of forming a knot 50 at one end of the roll of animal hide strips 40 is shown in FIGS. 4-6. The roll of animal hide strips 40 having a knot 50 at one end is shown in FIG. 6. A similar knotting operation is performed at the opposite end of the roll of animal hide strips 40, as shown in FIG. 7. The ends of the knots are pulled to tighten the knots. Excess material 60 at the end of the knots 50 are trimmed with a knife 70 as shown in FIG. 8.

FIGS. 9 and 10 show the finished pet chew bone of the invention, indicated generally at 100, which has a unique appearance in that substantial portions of the contrasting animal hide strips 10, 20 are visible on the exterior surface of the chew. That is, almost 50% of the colored animal hide strip 10 is visible, and almost 50% of the natural animal hide strip 20 is visible.

Optionally, food additives or supplements may be added to the rawhide, such as spices, extenders, vitamins, minerals, food additives, medicines, or other supplements, such as chemicals or enzymes capable of plaque and/or tartar removal from the animals's teeth. Attractants, such as various meat flavorings, as well as other flavorings and colorings, may be added in very small quantities to enhance the appeal of the dog chew to both the pet and its owner. As the chew is non-staining, addition of these additives will not discolor or damage clothing, carpets, or furniture.

The process of making non-staining animal hide chews will now be described. By non-staining is meant the process of impregnating the desired flavorings and/or colorants into the pet chew in such a manner as to bind the flavoring and/or colorant chemically to the chew so that the color or flavor will not leach out or impart color to the surrounding surfaces, so as not to discolor or damage clothing, carpets, or furniture.

Animal hide or rawhide is the inner layer of the hide of any cleft-hoofed livestock, which has been dehaired, disinfected, bleached and then dried, but not tanned. Rawhide is obtained from the natural skins of animals, most commonly cows, but rawhide may also be obtained from the skins of pigs, goats and water buffalos. The animal's skin is split into inner and outer layers. The top or outer layer or grain is usually tanned and used to make leather products. The inner layer of the hide, in its natural, untanned state, is rawhide which is used to make edible chew toys for dogs.

The animal hide splits are soaked in a lime based solution, to which may be added ammonium salts, sodium sulfide, or other additives, to remove hair from the hide. Following the liming treatment, the hair is removed from the hide, either manually or using a dehairing machine. The next step is to remove tissue from the flesh side of the hide, in a step known as “fleshing”, using a special knife or a fleshing machine. The hides are then rinsed thoroughly taking care to remove all the lime solution. After the hides are dehaired, fleshed, and rinsed, they may be cut into strips having the desired shape and size. The animal hide strips are joined together into the desired configuration by means of at least one operation selected from the group consisting of intertwining, tying, binding, rolling, folding, overlaying, looping, braiding, twisting, wrapping and knotting. In the preferred embodiment, the animal hide strips are overlayed, rolled and tied in a knot at each end to form a knotted bone shape. This may be done entirely by hand or may be accomplished by machine.

The animal hide is treated, washed and cleaned by putting the animal hide spit in a processing drum, revolving with flowing clean water for about one hour. Colored and non-colored split are treated in separate drums. To neutralize the alkalinity of the animal hide split, a mixture of about 0.7% carbon dioxide and 0.7% ammonium sulphate is added per kilo of animal hide split introduced into the drum, and the drum is revolved for two hours. Alternatively, ammonium sulphate solution of 5% density is used. This is followed by washing with flowing clean water for an additional hour, until the pH reaches between 6.5 and 7.5, and preferably around 7. The animal hide split is then subjected to a disinfection and bleaching treatment as is known in the art using a hydrogen peroxide solution of up to 50% by volume, by adding 3.5% for colored split and 4.5% for non-colored split.

The bleached animal hide split is then drained and rinsed until all residual hydrogen peroxide is removed from the animal hide split. It is important that the hydrogen peroxide be completely rinsed off. The rinse cycle is repeated as many times as necessary to ensure that all the hydrogen peroxide is removed from the animal hide split. The duration of the rinse cycle is not critical so long as the process results in the removal of all the hydrogen peroxide from the split.

The next step is the coloring and/or flavoring of the hide to make the chew appealing to the pet's sense of taste, smell and vision. The term “coloring solution” as used herein is intended to mean colorants or dyes, and may optionally include flavoring agents and other additives and supplements that promote good health and growth. A coloring solution or marinade comprising one or more natural and/or artificial colors, and which may optionally comprise flavorings and additives which will impart a color, flavor or smell to the animal hide, is prepared, as is known in the art. Colorants, preferably formulated to match the flavor of the product, are well-known in the art. Typical flavors are meat and animal products such as chicken, turkey, beef, pork, meat and/or fat, cheese, peanut butter, garlic, salt, onion, oil, or combinations thereof. The flavoring solution may include chunks of flavored bits or pieces, such as chunks of peanut butter or peanuts, bacon, lamb and rice, etc.

It is preferred that the colorants and flavorants be uniformly distributed throughout the chew so that the chew continues to attract the dog throughout the life of the chew. To prepare the coloring solution, the desired colors and/or flavors and additives are combined and dissolved in water, preferably in a ratio of 2.5 grams of mixed color per liter of water. The animal hide split is marinated in the coloring solution for a sufficient time to allow the color and/or flavor to penetrate all parts of the animal hide. The coloring solution is added slowly, preferably at a rate of about one liter per minute, into a running drum containing the bleached and rinsed animal hide split until the desired color is achieved. The drum is rotated slowly and allowed to run for a sufficient time to ensure an even distribution of color to the animal hide split, to avoid over-concentrating the coloring solution to one area of the drum. The coloring solution impregnates and diffuses into the animal hide until its concentration in the animal hide is substantially equal to its concentration in the solution. This results in the colorants penetrating the hide and becoming impregnated into the animal hide so that it chemically binds to the hide.

To set the color and render it non-staining, the animal hide split is then processed to a final pH of between 5.0-5.8 by adding an edible acid. While the coloring solution is in the drum with the animal hide, an amount of an edible acid sufficient to “fix” the color and flavor in the animal hide is added to the drum. The acid helps the color penetrate into the hide and results in the color being “fixed” in the hide, so the color will not leach out. The acid is poured slowly into the rotating drum. Preferably, the amount of acid added equals about 1% of the weight of the hide that is in the drum. Once the acid is fully poured into the drum, the drum is allowed to rotate for a sufficient time, usually between 20 to 60 minutes, to bring the pH of the contents of the drum to a range of 5.0 to 5.8, and preferably in the range of 5.0 to 5.5.

The acid to be added is not critical, and may comprise any of a number of edible acids, so long as the edible acid when added to the contents of the drum brings the pH to a range of 5.0 to 5.8. The acid is preferably selected from the group of edible acids consisting of acetic acid, citric acid, and lactic acid. The strength of the acid varies depending on the specific acid used and the amount of animal hide in the drum, but must be strong enough to bring the pH of the colored hides to a range of 5.0-5.8. The preferred acid is acetic acid in a ratio of 1 part acetic acid to 5 parts of water.

When the pH of the colored hides has reached the range of 5.0 to 5.8, the acid bath is complete, meaning that a majority of the color has been fixed in the animal hide split. The next step is to rinse the superficial non-fixed color from the animal hide split until all traces of superficial non-fixed color are removed. This may be accomplished by adding a rinse solution of an edible acid in water to the rotating drum, so that the acid continues to fix the existing color as the hides are rinsed and the excess drained. For instance, the hides may be rinsed with a solution of acetic acid and water prepared by mixing about 0.22% of acetic acid by weight of the split.

The colored and/or flavored split is now unloaded from the drum and preferably allowed to lay flat and rest for a period, up to about 3 hours, to allow the color to set fast into the rawhide.

Excess water is then removed, such as by squeezing water out of the skin by pressing the hide between two pinch rollers. The animal hide is then cut into proper size for the products that are to be made. The cut strips are then assembled into the desired configurations, i.e., bones, bagels, retriever rolls, or other shapes. Contrasting animal hide strips are joined together into the desired configuration by means of at least one operation selected from the group consisting of intertwining, tying, binding, rolling, folding, overlaying, looping, braiding, twisting, wrapping and knotting.

The chews are then subjected to a drying process to reduce the moisture content and thus the water activity of the chews, thereby reducing the likelihood that mold, bacteria or fungus growth will contaminate the chew. However, as insufficient moisture will result in a chew that looks and feels hard, care is taken to avoid over-drying the chew. The chew is dried and sterilized by exposing the chew to a suitable temperature for a sufficient time to effect drying and sterilizing. The assembled animal hide chews are dehydrated and dried as is known in the art by subjecting them to temperatures in the range of 45° C.-80° C., and preferably at temperatures of 45° C. -50° C., for at least 36 hours. The shaped animal hide chews may be dried by placing them on vented, bakery-type racks in an oven or in a drying room where moisture is slowly extracted from the rawhide so that the inside and the outside of the chews dries. Reducing the drying time may result in an externally hard chew having internal moisture, which is undesirable.

The chews of the invention have a unique commercial appearance, so that consumers immediately recognize and identify the product. The animal hide chews have a unique contrasting appearance, with no bleeding or rubbing off of the color of one constituent animal hide strip onto another animal hide strip or onto other surfaces.

Optionally, food additives or supplements may be added in the coloring solution, such as spices, extenders, vitamins, minerals, food additives, medicines or other supplements, such as chemicals or enzymes capable of plaque and/or tartar removal from the animal's teeth, and preservatives. Alternatively, if flavorants are not included in the coloring solution, the flavoring step may be performed anytime after the non-stain, colorfast process is completed, such as before the cutting and assembly operation commences, or after the chew is formed. The flavoring step may be accomplished by means of at least one operation selected from the group consisting of dipping, soaking, basting, spraying, marinating or painting the flavor onto the chew. The flavoring and/or additives are preferably impregnated into the chew by means of one of these known operations. For instance, the formed chews may be immersed or soaked in a solution comprising an effective concentration of the flavoring agent or additive for a sufficient period of time for the flavoring agent or additive to substantially infiltrate and absorb into the chew. Alternatively, following assembly, the chew may be treated by spraying it with a solution of the desired flavoring agents or additives, which absorb into the chew. The flavored chew is then dried. Thus, while it is preferred to flavor the hides during the manufacturing process, it is possible to flavor the chews post-assembly by soaking the bone in a flavoring solution for a sufficient period of time to absorb an effective amount of flavor. The flavored chew is then dried.

The pet chew may be formulated to provide optimum pet nutrition, health and oral hygiene and to bolster immunity. Optionally, the coloring solution may incorporate at least one nutrient selected from the group consisting of vitamins, minerals, herbs, anti-oxidants and nutritional supplements. The vitamins may include, but are not limited to one or more members of the group consisting of vitamins A, C, D, E, B, B_{1,}B₂,B_{3,}B₁₂, K, biotin (vitamin H), thiamine, niacin, folic acid, riboflavin, biotin, panthothenic acid, pyridoxine, choline, and mixtures thereof. The nutritional supplements may include glucosamine and chondroiton. One or more minerals selected from the group consisting of calcium, potassium, sodium, chloride, magnesium, phosphorus, iron, copper, manganese, zinc, iodine, selenium, cobalt, and mixtures thereof may be added to the baste solution in major or trace amounts. The herbs may be selected from the group consisting of echinacea, glucosamine, St. Johns Wort, Ginkgo biloba, ginseng, goldenseal, flax seed, rosemary, anise, camomile, valerian, nettle leaf, raspberry leaf, hyssop, yucca, sage and mixtures thereof. These herbs may be added, in proper amounts and ratios as is known in the art, for optimum pet nutrition and health.

Optionally, the coloring solution may incorporate an oral care agent or dental additive, which may include anti-plaque agents, tartar control agents, breath fresheners, and cleaning abrasives to help clean teeth and gums, promote good oral hygiene and prevent or reduce stain, decay, plaque, tartar or other build-up from the dog's teeth. Oral care additives in sufficient concentration to provide an oral hygiene effect may include therapeutic oral care agents selected from the group consisting of fluoride, sodium fluoride, potassium fluoride, stannous fluoride, stannous chlorofluoride, sodium monofluorophosphate, calcium pyrophosphate, sodium tripolyphosphate, zinc citrate, calcium hydrogen phosphate, peppermint oil, spearmint oil, sorbitol and sorbitan, and mixtures thereof. Breath-freshening agents may comprise dementholized peppermint oil, spearmint oil, sorbitol, and sorbitan. Other compounds known in the art may for these purposes may be used, as well.

The pet chew may also function as a delivery system to deliver pharmaceutical agents to the pet. The pharmaceutical agents are selected from the group consisting of anti-inflammatory agents, antibiotics, anti-parasitic agents, and animal-coat enhancing compounds, but may include other compounds as well. These additives may be added to the coloring solution to enhance and promote the pet's healthy coat, skin and hair. At least one of the constituent animal hide strip may incorporate the pharmaceutical agent in the recommended dosage for the size of animal to consume the product, as is known in the art.

It is known that dietary fats and oils help a pet maintain a healthy coat of fur. Fatty acids and oils such as flax seed oil, sunflower oil, linolenic acid, beef fat, pork fat, and chicken fat, fish meal, and fish oil may be added to the coloring solution. Lecithin helps promote digestion and absorption of fats necessary for healthy coat maintenance.

The additives and nutrients are preferably added to the coloring or flavoring solutions in the amount of about 5% by weight of the animal hides, it being understood that higher or lower concentrations may be added to suit the pet's nutritional requirements. The nature and concentrations of additives set forth herein are not meant to be limiting, as it is contemplated that other additives and concentrations may be equally effective and may be used without departing from the invention. To prevent inactivation or degradation of the additives, excessive processing temperatures should be avoided.

It will be understood that the embodiments described herein are merely exemplary and that a person skilled in the art may make many variations and modifications without departing from the spirit and scope of the invention. For example, the invention is not intended to be strictly limited to the named ingredients, temperatures, or other parameters. Rather, the invention as claimed extends to many possible variations not specifically detailed. All such variations and modifications are intended to be included in the scope of the invention as described herein.

We claim:

1. A pet chew comprising a plurality of contrasting animal hide strips joined together,
at least one of said plurality of contrasting animal hide strips treated to be non-staining,
said pet chew configured to display substantial portions of each of said plurality of contrasting animal hide strips on the exterior surface of the chew.

2. The chew of claim 1 wherein said contrasting animal hide strips contrast in at least one of flavor, color, texture and material.

3. The chew of claim 1 wherein said animal hide strips are joined together by means of at least one operation selected from the group consisting of intertwining, tying, binding, rolling, folding, overlaying, looping, braiding, twisting, wrapping and knotting.

4. The chew of claim 1 wherein at least one of said plurality of contrasting animal hide strips treated to be non-staining is flavored with a flavoring agent.

5. The chew of claim 1 wherein at least one of said plurality of contrasting animal hide strips treated to be non-staining is flavored with a flavoring agent and at least another of said plurality of contrasting animal hide strips treated to be non-staining is flavored with a different flavoring agent.

6. The chew of claim 1 wherein at least one of said plurality of contrasting animal hide strips treated to be non-staining is colored with a colorant.

7. The chew of claim 1 wherein at least one of said plurality of contrasting animal hide strips treated to be non-staining is colored with a colorant and at least another of said plurality of contrasting animal hide strips treated to be non-staining is colored with a different colorant.

8. The chew of claim 1 wherein at least one of said plurality of contrasting animal hide strips treated to be non-staining is textured with a texture appetizing to a pet.

9. The chew of claim 1 wherein at least one of said plurality of contrasting animal hide strips treated to be non-staining is obtained from the hide of a first animal species and at least another of said plurality of contrasting animal hide strips is obtained from the hide of a second animal species different from said first animal species.

10. The chew of claim 9 wherein said contrasting animal hide strips are cowhide and pighide strips.

11. The chew of claim 1 wherein said chew is configured to display substantially equal portions of each of said plurality of contrasting animal hide strips on the exterior surface of the chew.

12. The chew of claim 1 wherein at least one of said contrasting animal hide strips further contains at least one additional ingredient selected from the group consisting of nutrients, dental additives, pharmaceutical compounds and mixtures thereof.

13. The chew of claim 11 wherein said nutrients are selected from the group consisting of vitamins, minerals, herbs, anti-oxidants, and nutritional supplements.

14. The chew of claim 11 wherein said pharmaceutical compounds are selected from the group consisting of anti-inflammatory agents, antibiotics, anti-parasitic agents, and animal-coat enhancing compounds.

15. The chew of claim 1, wherein said chew has the configuration of a knotted bone.

16. The pet chew of claim 1 wherein at least one of said plurality of contrasting animal hide strips treated to be non-staining contacts a surface when the chew is placed upon the surface.

17. A method of making a non-staining pet chew comprising at least one colored component, comprising the steps of:
a. Providing animal hide split which has been cleaned and bleached;
b. Providing a coloring solution comprising a colorant;
c. Marinating the animal hide split in the coloring solution for a sufficient time to allow the coloring solution to penetrate the animal hide.
d. Fixing the color to prevent staining comprising adding a sufficient amount of an edible acid to the marinating animal hide split of step c. until a desired pH is achieved.
e. Cutting the split into strips having a desired configuration;
f. Forming at least one strip of step e. into a pet chew having a desired configuration.

18. The method of claim 17 wherein in step d. the desired pH is in the range of 5.0 to 5.8.

19. The method of claim 17 including, anytime after step d., an additional step of flavoring the chew by means of at least one operation selected from the group consisting of dipping, soaking, basting, spraying, marinating or painting.

20. The method of claim 17 including, after step f, an additional step of drying and sterilizing said pet chew by exposing said pet chew to a suitable temperature for a sufficient time to effect drying and sterilizing.
